(19) United States
(12) Patent Application Publication
(10) Pub. No.: US 2009/0168911 A1
(43) Pub. Date: Jul. 2, 2009

(54) APPARATUS AND METHOD FOR CHANNEL INFORMATION FEEDBACK IN MULTIPLE ANTENNA SYSTEM

(75) Inventors: Sung-Woo PARK, Suwon-si (KR); Soon-Young YOON, Seoul (KR); Jae-Hee CHO, Seoul (KR); Keun-Chul HWANG, Seongnam-si (KR); In-Seok HWANG, Seoul (KR); June MOON, Seoul (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/343,674

(22) Filed: Dec. 24, 2008

(30) Foreign Application Priority Data
Dec. 28, 2007 (KR) 10-2007-0139695

(51) Int. Cl. H04L 27/28

(52) U.S. Cl. 375/260

(57) ABSTRACT

An apparatus and method for channel information feedback in a multiple antenna system are provided. The method includes selecting at least one code for at least one Eigen vector based on channel information with a serving node from a codebook including at least one code, constructing a set of codes orthogonal to a first code including the at least one selected code, and indicating the first code using an amount of information that enables expression of the codes of the codebook, indicating codes, other than the first code, in the constructed set using an amount of information that enables expression of the codes included in the set and performing feedback to the serving node.

### PRIORITY

This application claims the benefit under 35 U.S.C. §119(a) of a Korean Patent Application filed on Dec. 28, 2007 in the Korean Intellectual Property Office and assigned Serial No. 10-2007-0139695, the entire disclosure of which is hereby incorporated by reference.

### BACKGROUND OF THE INVENTION

1. Field of the Invention

The present invention relates to an apparatus and method for channel information feedback in a multiple antenna system. More particularly, the present invention relates to an apparatus and method for feeding back channel information based on a codebook in the multiple antenna system.

2. Description of the Related Art

With rapid growth in a wireless mobile communication market, there is a demand for diversity in multimedia services. In order to provide multimedia services, research has been performed for multiple antenna systems achieving a large capacity of transmitted data and a high speed of data transmission while being able to efficiently utilize limited frequency resources. For example, the multiple antenna system includes a Multiple Input Multiple Output (MIMO) system.

A multiple antenna system transmits data from an antenna using an independent channel. Unlike a single antenna system, transmission reliability and a transmission rate may increase using the multiple antenna system without additional frequency or transmission power allocation.

The multiple antenna system provides several users with space resources secured through a multiple antenna in order to increase frequency efficiency. In the multiple antenna system, a serving Base Station (BS) may be aware of channel information of each user in order to provide services and allocate space resources to several users. For example, the serving BS acquires channel information of users for providing a closed-loop service.

When using a closed-loop scheme, user Mobile Stations (MSs) feedback channel information to a BS. For example, a user MS may quantize and feed back a value of a channel coefficient, or may select a preferable code using a predefined codebook and feed back the selected code.

When feeding back channel information based on a codebook, a user MS feeds back a code, which expresses a direction of a channel, and a size of a channel vector to a serving BS. For example, if a BS includes N_{T} antennas and a user MS includes a single antenna, a channel between the BS and the user MS is configured in a form of a (1×N_{T}) vector. In this case, the user MS expresses a direction of a channel vector by a code and feeds back the code to the BS.

As described above, when a user MS has a single receive antenna, the user MS selects a code for a channel vector, which is configured in a 1×N_{T} form, and feeds back the selected code to a BS.

However, if a user MS includes a plurality of receive antennas (N_{R}), a channel between the user MS and a BS is configured in a matrix having an N_{R}×N_{T} form. In this case, the user MS may transmit N_{R} number of codes for a channel vector of a 1×N_{T} form.

A problem exists when a multiple antenna system feeds back channel information based on a codebook, because an increase in a number of receive antennas of a user MS results in an increased feedback amount of channel information.

Therefore, a need exists for an apparatus and method for reducing a feedback amount in a multiple antenna system.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for reducing a feedback amount in a multiple antenna system.

Another aspect of the present invention is to provide an apparatus and method for feeding back channel information using Eigen vectors of channel information and Eigen values in a multiple antenna system.

Still another aspect of the present invention is to provide an apparatus and method for reducing a feedback amount using code orthogonally when feeding back channel information based on a codebook in a multiple antenna system.

Yet another aspect of the present invention is to provide an apparatus and method for channel information feedback in a multiple antenna system.

In accordance with an aspect of the present invention, a method for feeding back channel information in a multiple antenna system is provided. The method includes selecting at least one code for at least one Eigen vector based on channel information with a serving node from a codebook including at least one code, constructing a set of codes orthogonal to a first code comprising the at least one selected code, and indicating the first code using an amount of information that enables expression of the codes of the codebook, indicating codes, other than the first code, in the constructed set using an amount of information that enables expression of the codes included in the set and performing feedback to the serving node.

In accordance with another aspect of the present invention, a method for feeding back channel information in a multiple antenna system. The method includes selecting a code for a first Eigen vector having a largest Eigen value among at least one Eigen vector, based on channel information with a serving node in a codebook including at least one code, constructing a set of codes orthogonal to the code for the first Eigen vector in the codebook, selecting codes of Eigen vectors other than the first Eigen vector among the Eigen vectors based on the channel information with the serving node in the set, and feeding back the selected codes for the Eigen vectors to the serving node.

In accordance with yet another aspect of the present invention, an apparatus for feeding back channel information in a wireless communication system is provided. The apparatus includes at least two antennas, a channel estimator, a code selector, and a feedback controller. The at least two antennas receive signals. The channel estimator estimates a channel using the signals received from the antennas. The code selector selects at least one code for at least one Eigen vector based on channel information estimated in the channel estimator from a codebook including one or more codes. The feedback controller constructs a set of codes orthogonal to a first code that comprises the at least one code selected in the code selector, indicates the first code using an amount of information that enables expression of the codes of the codebook, indicates selected codes, other than the first code, using an amount of information that enables expression of codes constructing the set and controls and performs feedback to the serving node.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a flow diagram illustrating a process of channel information feedback in a multiple antenna system according to an exemplary embodiment of the present invention;

FIG. 2 is a flow diagram illustrating a process of channel information feedback in a multiple antenna system according to an exemplary embodiment of the present invention;

FIG. 3 is a block diagram illustrating a construction of a receive end for feeding back channel information in a multiple antenna system according to an exemplary embodiment of the present invention; and

FIG. 4 is a graph illustrating a variation of performance according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

A technology for reducing an overhead generated when feeding back channel information based on a codebook in a multiple antenna system according to an exemplary embodiment of the present invention is described below.

A multiple antenna system is described below with an assumption that the multiple antenna system uses a non-unitary multiple antenna technique of a linear series. Thus, a serving node generates a precoder for transmitting a signal using a code indicating channel state information received from Mobile Stations (MSs). The serving node represents a transmit end for providing a service to MSs. The precoder represents a precoder matrix or a precoder vector.

When using a non-unitary multiple antenna technique, a serving node may generate a precoder for transmitting a signal to MSs using only channel matrix (H) information and H^{H}H information.

Thus, in order to feed back H^{H}H information in place of channel matrix (H) information, MSs feed back codes including information regarding Eigen vectors for the same number of H^{H}H information as a number (N_{R}) of receive antennas and a ratio of Eigen values of (N_{R}−1) number, to a Base Station (BS).

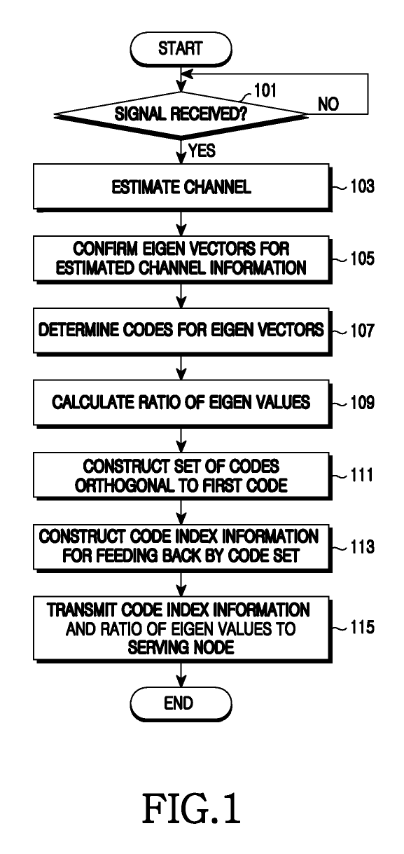

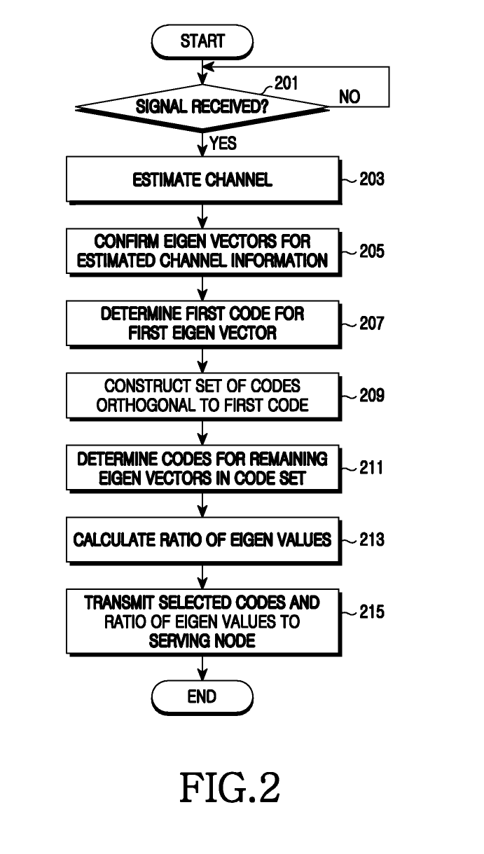

When there is a set of orthogonal codes within a codebook generated to feed back channel information in a multiple antenna system, MSs may reduce an overhead caused by feedback using the orthogonal characteristics of Eigen vectors. For example, an MS may feed back channel information through a process in FIG. 1 or FIG. 2.

FIG. 1 is a flow diagram illustrating a process of channel information feedback in a multiple antenna system according to an exemplary embodiment of the present invention.

Referring to FIG. 1, in step 101, an MS identifies if a signal is received from a serving node. The serving node, which denotes a node providing a service received by an MS, may include a BS or a Relay Station (RS).

If a signal is received from the serving node, in step 103, the MS estimates a channel with the serving node using the signal received through the N_{R} number of receive antennas. If a signal is not received, the MS performs step 101 again.

After estimating the channel, in step 105, the MS confirms Eigen vectors for feeding back the estimated channel information. That is, if using a non-unitary multiple antenna technique, the serving node may generate a precoder for transmitting a signal using H^{H}H information in addition to channel matrix (H) information. Thus, the MS identifies Eigen vectors for H^{H}H information to feed back the H^{H}H information. For example, the MS identifies Eigen vectors for H^{H}H information as given in Equation 1 below:

H^{H}H=UDU^{H}=u₁d₁u₁^{H}+ . . . +u_{N}_{_{R}}d_{N}_{_{R}}u_{N}_{_{R}}^{H} (1)

In Equation 1, the ‘H’ denotes a channel matrix with the serving node, the ‘U’ denotes a unitary matrix constructed by (number (N_{T}) of transmit antennas of serving node constructed by Eigen vectors)×(number (N_{R}) of receive antennas of MS), and the ‘u_{N}_{_{R}}’ denotes an Eigen vector. Also, the ‘D’ denotes a set of Eigen values and the ‘d_{N}_{_{R}}’ denotes an Eigen value. Here, the Eigen values have a feature of d₁≧ . . . ≧d_{N}_{_{R}}.

As given in Equation 1, the MS identifies Eigen vectors for H^{H}H information and Eigen values from Eigen value decomposition.

After confirming the Eigen vectors for feeding back the channel information, in step 107, the MS determines a code to include information on each Eigen vector in a predefined codebook. That is, the MS selects codes most approximate to respective Eigen vectors from a codebook.

After determining the code, in step 109, the MS calculates a ratio for the Eigen values identified in step 105. For example, the MS may calculate a ratio of Eigen values as given in Equation 2 below. Although not shown, the MS may feed back the code determined in step 107 and the Eigen value ratio calculated in step 109 to the serving node.

u₁, . . . ,u_{N}_{_{R}} and d₂/d₁, . . . ,d_{N}_{_{R}}/d₁ (2)

In Equation 2, the ‘u_{N}_{_{R}}’ denotes an Eigen vector, and the ‘d_{N}_{_{R}}/d₁’ denotes a ratio of Eigen values.

If there are orthogonal codes within the codebook, in step 111, the MS constructs a set of codes orthogonal to a code for a first Eigen vector for the purpose of reducing a feedback overhead. For example, a Discrete Fourier Transform (DFT) codebook includes codes located at regular intervals that are orthogonal to each other. Thus, when using the DFT codebook, the MS constructs, as a set, codes located at regular intervals from a code for a first Eigen vector. Here, an MS constructs a set of codes orthogonal to a code for a first Eigen vector, but may also construct a set of codes orthogonal to codes for arbitrary Eigen vectors.

After constructing a set of orthogonal codes, in step 113, the MS again sets indexes of the codes included in the set to reduce a feedback amount. For example, if a codebook includes N_{C} number of codes, an MS requires log₂ N_{C} bits to feed back a single code. Thus, the MS requires N_{R}×log₂N_{C} bits to feed back codes for N_{R} number of Eigen vectors of. However, if newly setting indexes of codes of N_{sub} number (N_{C}>N_{sub}) included in a set of orthogonal codes, the MS requires log₂ N_{C}+{(N_{R}−1)×log₂ N_{sub}} bits to feed back codes for Eigen vectors. That is, the MS indicates a code for a first Eigen vector by bits enabling expression of the codes of a codebook and indicates codes for remaining Eigen vectors by bits enabling expression of codes included in the set. Thus, a feedback amount may be reduced.

After setting code index information for feed back again, in step 115, the MS transmits the code index information and the Eigen value ratio information to a serving BS.

The MS then terminates the process according to an exemplary embodiment of the present invention.

FIG. 2 is a flow diagram illustrating a process of channel information feedback in a multiple antenna system according to an exemplary embodiment of the present invention.

Referring to FIG. 2, in step 201, an MS identifies if a signal is received from a serving node. The serving node, which denotes a node providing a service received by an MS, may include a BS or an RS.

If a signal is received from the serving node, in step 203, the MS estimates a channel with the serving node using the signal received through N_{R} number of receive antennas. If a signal is not received, the MS performs step 201 again.

After estimating the channel, in step 205, the MS confirms Eigen vectors for feeding back estimated channel information. That is, when using a non-unitary multiple antenna technique, the serving node may generate a precoder for transmitting a signal to MSs located in a service area using H^{H}H information in addition to channel matrix (H) information. Thus, the MS identifies the Eigen vectors for the H^{H}H information as given in Equation 1 to feed back the H^{H}H information.

After confirming the Eigen vectors, in step 207, the MS determines a code for a first Eigen vector in a predefined codebook.

If the codebook includes orthogonal codes, in step 209, the MS constructs a set of codes orthogonal to a code for a first Eigen vector to reduce a feedback overhead. For example, a DFT codebook includes codes located at regular intervals that are orthogonal to each other. Thus, when using the DFT codebook, the MS constructs a set of codes located at regular intervals from a code for a first Eigen vector.

After constructing the set of orthogonal codes, in step 211, the MS determines codes for Eigen vectors other than the first Eigen vector in the set of codes constructed in step 209. That is, Eigen vectors are orthogonal to each other and codes for respective Eigen vectors are also orthogonal to each other. Thus, the MS determines codes for remaining Eigen vectors in the set of codes orthogonal to the code of the first Eigen vector.

After determining the codes for the Eigen vectors, in step 213, the MS calculates a ratio for the Eigen vectors identified in step 205.

After determining the codes for the Eigen vectors and calculating the Eigen value ratio, in step 215, the MS transmits the codes for the Eigen vectors and the Eigen value ratio to a serving node. At this time, the MS indicates a code for a first Eigen vector using a number of bits that enable expression of the codes included in a codebook, indicates codes for remaining Eigen vectors using a number of bits that enable expression of codes included in the set and performs feedback. For example, if a codebook includes N_{C} number of codes and there are N_{sub} number of orthogonal codes (N_{C}>N_{sub}) among the N_{C} number of codes, the MS feeds back a code for a first Eigen vector using log₂ N_{C} number of bits, and feeds back remaining codes using log₂ N_{sub} number of bits, respectively.

The MS then terminates the process according to an exemplary embodiment of the present invention.

In an exemplary implementation, the MS identifies Eigen vectors for H^{H}H information and Eigen values by performing Eigen value decomposition of Equation 1 in order to feed back the H^{H}H information. Then, the MS determines and feeds back codes for the identified Eigen vectors to a serving node.

In an exemplary embodiment of the present invention, the MS may determine codes of Eigen vectors for H^{H}H information without performing Eigen value decomposition, using Equations 3 and 4 below.

The MS may select a code for a first Eigen vector without performing Eigen value decomposition, using Equation 3 below:

$${k}_{1} = {arg max}_{n = 0 , … , {N}_{C} - 1} {c}_{n}^{H} {H}^{H} H {c}_{n} \qquad ( 3 )$$

In Equation 3, the ‘k₁’ denotes a code for a first Eigen vector, the ‘N_{C}’ denotes a number of codes included in a codebook, the ‘cₙ’ denotes an n^{th} code among the codes included in the codebook, and the ‘H’ denotes a channel matrix with a serving node.

An Eigen value for a first Eigen vector is larger than Eigen vectors of H^{H}H information. Thus, the MS determines, as a code of a first Eigen vector, a code having a best correlation characteristic with a channel among codes of a codebook as given in Equation 3.

After determining the code for the first Eigen vector, the MS may select codes for remaining Eigen vectors by applying codes other than the selected code to Equation 3.

Also, if there are orthogonal codes within a codebook, the MS constructs a set for codes orthogonal to a code for a first Eigen vector to reduce a feedback overhead.

At this time, the MS may select codes for Eigen vectors other than the first Eigen vector using only a code within the set as given in Equation 4 below:

$${k}_{2} = {arg max}_{n = 1 , … , {N}_{sub}} {\tilde{c}}_{n}^{H} {H}^{H} H {\tilde{c}}_{n} \\ where , {\tilde{c}}_{n} ∈ orthogonal Subset of {k}_{1} , {N}_{sub} = size of Subset \\ {k}_{2} = {arg max}_{n = 1 , … , {N}_{T}} {c}_{{( {k}_{1} + nS )}_{mod {N}_{c}}}^{H} {H}^{H} {Hc}_{{( {k}_{1} + nS )}_{mod {N}_{c}}} \\ where , S = {N}_{C} / {N}_{T} \qquad ( 4 )$$

In Equation 4, the ‘k₂’ denotes a code for a second Eigen vector, the ‘N_{T}’ denotes a number of codes orthogonal to a code for a first Eigen vector in a DFT codebook, and the ‘N_{sub}’ denotes a number of codes included in a set of the codes orthogonal to the code for the first Eigen vector. Also, the ‘cₙ’ denotes an n^{th} code among codes included in the codebook, the ‘\tilde{c}ₙ’ denotes an n^{th} code among codes included in the set of orthogonal codes, the ‘H’ denotes a channel matrix with a serving node and the ‘S’ denotes an interval of orthogonal codes in the DFT codebook.

Eigen vectors of H^{H}H information have components orthogonal to each other and codes for the respective Eigen vectors are also orthogonal to each other. An Eigen value for a second Eigen vector is the largest Eigen value after an Eigen value of a first Eigen vector. Thus, the MS determines, as a code of the second Eigen vector, a code having the best correlation characteristic with a channel among codes orthogonal to the code of the first Eigen vector as given in Equation 4.

Then, the MS eliminates codes selected from the set of the codes orthogonal to the code of the first Eigen vector while selecting codes for remaining Eigen vectors by repeatedly performing Equation 4.

At this time, the MS does not perform Eigen value decomposition, but the MS calculates a ratio of Eigen values using Equation 5 below:

$${r}_{n} = {Quantize}_{Q - bit} ( \frac{{c}_{{( {k}_{1} + nS )}_{mod {N}_{C}}}^{H} {H}^{H} H {c}_{{( {k}_{1} + nS )}_{mod {N}_{C}}}}{{c}_{{k}_{1}}^{H} {H}^{H} H {c}_{k 1}} ) \\ ( S = {N}_{C} / {N}_{T} , n = 1 , … , {N}_{R} - 1 ) \qquad ( 5 )$$

In Equation 5, the ‘rₙ’ denotes a ratio of first Eigen value to n^{th} Eigen value, the ‘cₖ_{₁}’ denotes a code for the first Eigen vector, the ‘c₍ₖ_{₁}_{+nS)mod N}_{_{C}}’ denotes a code for the n^{th} Eigen vector. Also, the ‘N_{C}’ denotes a number of codes included in a codebook, and the ‘N_{T}’ denotes a number of codes included in a set of codes orthogonal to the code for the first Eigen vector among the codes included in the codebook.

An exemplary construction of an MS for feeding back codes for Eigen vectors of H^{H}H information and a ratio of Eigen values is described below.

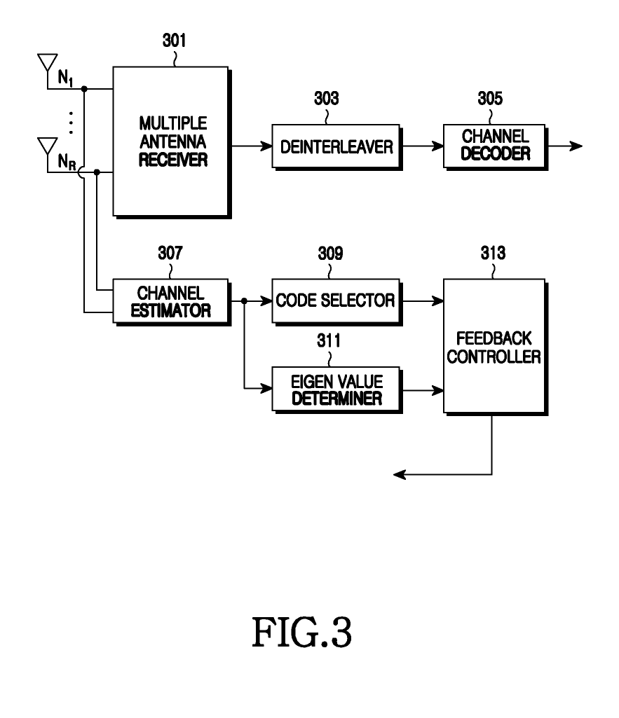

FIG. 3 is a block diagram illustrating a construction of a receive end for feeding back channel information in a multiple antenna system according to an exemplary embodiment of the present invention.

As shown in FIG. 3, an MS includes a plurality of receive antennas (N_{R}), a multiple antenna receiver 301, a deinterleaver 303, a channel decoder 305, a channel estimator 307, a code selector 309, an Eigen value determiner 311 and a feedback controller 313.

The multiple antenna receiver 301 detects a signal transmitted by a serving node among multiplexed signals received from the receive antennas.

The deinterleaver 303 deinterleaves a signal provided from the multiple antenna receiver 301 in compliance with an interleaving rule corresponding to an interleaver of a serving node.

The channel decoder 305 demodulates and decodes a signal provided from the deinterleaver 303 according to a corresponding modulation level. The corresponding modulation level denotes a Modulation and Coding Scheme (MCS) level.

The channel estimator 307 estimates a channel with a serving node using a signal received from the receive antenna. Although not shown, an Eigen value decomposer is positioned between the channel estimator 307 and the code selector 309. The Eigen value decomposer identifies Eigen vectors and Eigen values for channels estimated in the channel estimator 307 through Eigen value decomposition of Equation 1. The Eigen value decomposer transmits the identified Eigen vectors and Eigen values to the code selector 309. Also, the Eigen value decomposer transmits information regarding the identified Eigen values to the Eigen value determiner 311.

The code selector 309 selects codes for Eigen vectors of channels estimated in the channel estimator 307 from a codebook. That is, the code selector 309 selects codes most approximate to Eigen vectors of estimated channels from the codebook.

The Eigen value determiner 311 calculates a ratio of Eigen values for channels estimated in the channel estimator 307. For example, the Eigen value determiner 311 calculates a ratio of Eigen values provided from the Eigen value decomposer as given in Equation 2.

The feedback controller 313 controls and feeds back codes for Eigen vectors provided from the code selector 309 and a ratio of Eigen values provided from the Eigen value determiner 311 to a serving node. The feedback controller 313 indicates a code for a first Eigen vector using a number of bits that enable expression of the codes included in a codebook, indicates codes for remaining Eigen vectors using a number of bits that enable expression of codes included in a set of codes orthogonal to the code for the first Eigen vector and performs feed back. For example, if a codebook includes N_{C} number of codes and, among the codes, there are N_{sub} number of orthogonal codes (N_{C}>N_{sub}), the feedback controller 313 feeds back a code for a first Eigen vector using log₂ N_{C} number of bits and feeds back remaining codes using log₂ N_{sub} number of bits, respectively.

In the aforementioned exemplary embodiment of the present invention, an MS identifies Eigen vectors for channel information with a serving node and Eigen values, using an Eigen value decomposer. Thus, the code selector 309 selects codes for the Eigen vectors provided from the Eigen value decomposer in a codebook. Also, the Eigen value determiner 311 calculates a ratio for the Eigen values provided from the Eigen value decomposer.

In an exemplary embodiment of the present invention, an MS may calculate codes for Eigen vectors and a ratio of Eigen values without using Eigen value decomposition. That is, the code selector 309 may sequentially select codes having the best correlation characteristics with channel information provided from the channel estimator 307 as given in Equation 3. Here, a code first selected in the code selector 309 becomes a code of a first Eigen vector.

The Eigen value calculator 311 may calculate a ratio of Eigen values using Equation 5, without using Eigen value decomposition.

The following description is for a variation of performance, when feeding back an Eigen vector for channel information and an Eigen value using the codes included in a codebook that are orthogonal to each other. The following description is based on the assumption that a serving node includes four transmit antennas, an MS includes two receive antennas and 6 bits are required to express codes in a codebook.

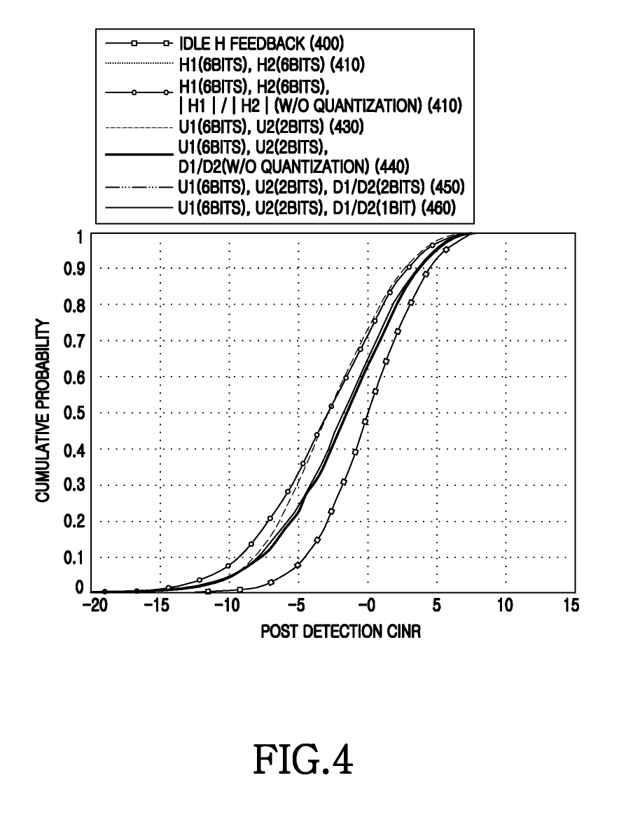

FIG. 4 is a graph illustrating a variation of performance according to an exemplary embodiment of the present invention. A horizontal axis denotes a Carrier to Interference and Noise Ratio (CINR) and a vertical axis denotes a cumulative probability.

As shown in FIG. 4, if MSs accurately feed back channel information with a serving node (400), optimal performance is shown. However, a problem exists in which an overhead caused by feedback increases.

Thus, MSs feed back channel characteristics to a serving node using codes capable of expressing the channel characteristics.

Conventional MSs may select codes for respective channel vectors, and feed back the selected codes using a number of bits (e.g., 6 bits) that enable expression of the codes of a codebook (410, 420). In an exemplary embodiment of the present invention, the MSs may feed back a code for a first Eigen vector using a number of bits (e.g., 6 bits) that enable expression of the codes of a codebook and feed back codes for remaining Eigen vectors using a number of bits (e.g., 2 bits) that enable expression of codes orthogonal to the code for the first Eigen vector (430, 440, 450 and 460).

As described above, an exemplary embodiment of the present invention may reduce a feedback amount when feeding back channel information. If a codebook includes an unlimited size, the performance is the same when feeding back the information on the channel vectors and when feeding back information on an Eigen vector.

However, when a correlation characteristic between channels is large, such as 0.7 as assumed in FIG. 4, elements of a channel vector (h1) of a first receive antenna and elements of a channel vector (h2) of a second receive antenna have a similar correlation on average. If a size of a codebook is limited to, for example, 6 bits, an MS selects the same code for the channel vector (h1) and channel vector (h2). Thus, the probability of generating an error may increase. On the contrary, as shown in FIG. 4, because the probability of generating an error is low, if a size of a codebook is limited, better performance of the MS may be shown (400, 410).

As described above, exemplary embodiments of the present invention may reduce a feedback amount and improve feedback performance, if a codebook includes a limited size, by constructing a set of orthogonal codes using an orthogonal component of an Eigen vector and feeding back channel information in a multiple antenna system for feeding back channel information based on the codebook.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for feeding back channel information in a multiple antenna system, the method comprising:
selecting at least one code for at least one Eigen vector based on channel information with a serving node from a codebook comprising at least one code; constructing a set of codes orthogonal to a first code comprising the at least one selected code; and
indicating the first code using an amount of information that enables expression of the codes of the codebook, indicating codes, other than the first code, in the constructed set using an amount of information that enables expression of the codes comprised in the set and performing feedback to the serving node.

2. The method of claim 1, further comprising:
estimating a channel using a signal received from the serving node; and
confirming the at least one Eigen vector based on the estimated channel and Eigen values for respective Eigen vectors from Eigen value decomposition,
wherein the codes for the identified Eigen vectors are selected from the codebook.

3. The method of claim 1, wherein the first code comprises a code for an Eigen vector comprising a largest Eigen value among the Eigen vectors, based on the channel information with the serving node.

4. The method of claim 1, wherein the selecting of the at least one code comprises:
selecting, as a code of a first Eigen vector, a code comprising a best correlation characteristic for the channel information with the serving node among the codes comprised in the codebook; and
selecting, as a code of a second Eigen vector, a code comprising a correlation characteristic for the channel information with the serving node among codes other than the code selected as the code of the first Eigen vector in the codebook.

5. The method of claim 4, further comprising:
determining whether all codes for the at least one Eigen vector comprised in the channel information with the serving node are selected;
eliminating the at least one code selected as the code of the Eigen vector from the codebook, if all the codes for the Eigen vectors are not selected; and
selecting, as a code of a next Eigen vector, a code comprising a correlation characteristic for the channel information with the serving node among codes comprised in the codebook eliminating the selected codes.

6. The method of claim 1, wherein the selecting of the at least one code comprises selecting a code of an Eigen vector using the following Equation:
$${k}_{1} = {arg max}_{n = 0 , … , {N}_{C} - 1} {c}_{n}^{H} {H}^{H} H {c}_{n}$$
wherein,
k₁ denotes a code for first Eigen vector,
N_{C} denotes a number of codes comprised in the codebook,
cₙ denotes an n^{th} code among codes comprised in the codebook, and
H denotes a channel matrix with the serving node.

7. The method of claim 1, further comprising:
after selecting the at least one code, calculating a ratio of Eigen values for the channel information with the serving node; wherein the performing feedback comprises:
performing feedback of the ratio of Eigen values and the selected codes for Eigen vectors to the serving node.

8. A method for feeding back channel information in a multiple antenna system, the method comprising:
selecting a code for a first Eigen vector comprising a largest Eigen value among at least one Eigen vector based on channel information with a serving node in a codebook comprising at least one code;
constructing a set of codes orthogonal to the code for the first Eigen vector in the codebook;
selecting codes of Eigen vectors other than the first Eigen vector among the Eigen vectors based on the channel information with the serving node in the set; and
feeding back the selected codes for the Eigen vectors to the serving node.

9. The method of claim 8, further comprising:
estimating a channel using a signal received from the serving node; and
confirming the at least one Eigen vector based on the estimated channel information and Eigen values for respective Eigen vectors from Eigen value decomposition,
wherein the code for the first Eigen vector among identified Eigen vectors is selected from the codebook.

10. The method of claim 8, wherein the selecting of the code of the first Eigen vector comprises selecting, as the code of the first Eigen vector, a code comprising a best correlation characteristic for the channel information with the serving node among the at least one code comprised in the codebook.

11. The method of claim 8, wherein the code of the first Eigen vector comprises a selected code satisfying the following Equation:
$${k}_{1} = {arg max}_{n = 0 , … , {N}_{C} - 1} {c}_{n}^{H} {H}^{H} H {c}_{n}$$
wherein,
k₁ denotes a code for the first Eigen vector,
N_{C} denotes a number of codes comprised in the codebook,
cₙ denotes an n^{th} code among codes comprised in the codebook, and
H denotes a channel matrix with the serving node.

12. The method of claim 8, wherein the selecting of the codes of the Eigen vectors, other than the first Eigen vector, comprises:
eliminating the codes selected as the codes for Eigen vectors from the set of codes orthogonal to the code for the first Eigen vector; and
selecting, as a code of a next Eigen vector, a code comprising a best correlation characteristic for the channel information with the serving node among codes comprised in the set eliminating the selected codes.

13. The method of claim 12, further comprising determining whether all codes for respective Eigen vectors comprised in the channel information with the serving node are selected,
wherein, if all the codes for the Eigen vectors are not selected, codes for the Eigen vectors that are not selected are further selected.

14. The method of claim 12, wherein a code for a second Eigen vector is a selected code satisfying the following Equation:
$${k}_{2} = {arg max}_{n = 1 , … , {N}_{sub}} {\tilde{c}}_{n}^{H} {H}^{H} H {\tilde{c}}_{n}$$
where, \tilde{c}ₙ ∈ orthogonal Subset of k₁, N_{sub}=size of Subset
wherein,
k₂ denotes a code for a second Eigen vector,
N_{sub} denotes a number of codes comprised in the set of codes orthogonal to the code for the first Eigen vector,
\tilde{c}ₙ denotes an n^{th} code among codes comprised in the set, and
H denotes a channel matrix with the serving node.

15. The method of claim 8, wherein the feeding back of the selected codes comprises:
indicating the code for the first Eigen vector using an amount of information that enables expression of the codes of the codebook and performing feedback to the serving node;
indicating codes for Eigen vectors other than the first Eigen vector using an amount of information that enables expression of codes constructing the set; and
performing feedback to the serving node.

16. The method of claim 8, further comprising:
after constructing the set, calculating a ratio of Eigen values for the channel information with the serving node; and
wherein the performing feedback comprises:
performing feedback of the ratio of Eigen values and the selected codes for Eigen vectors to the serving node.

17. An apparatus for feeding back channel information in a wireless communication system, the apparatus comprising:
at least two antennas for receiving signals;
a channel estimator for estimating a channel using the signals received from the antennas;
a code selector for selecting at least one code for at least one Eigen vector based on channel information estimated in the channel estimator from a codebook comprising at least one code; and
a feedback controller for constructing a set of codes orthogonal to a first code that comprises the at least one code selected in the code selector, indicating the first code using an amount of information that enables expression of the codes of the codebook, indicating selected codes, other than the first code, using an amount of information that enables expression of codes constructing the set and controlling and performing feedback to the serving node.

18. The apparatus of claim 17, further comprising an Eigen value composer for confirming at least one Eigen vector based on the estimated channel information and Eigen values for respective Eigen vectors from Eigen value decomposition,
wherein the code selector selects codes for respective Eigen vectors identified in the Eigen value decomposition.

19. The apparatus of claim 17, wherein the code selector selects a code for each Eigen vector by calculating a correlation characteristic between the channel information estimated in the channel estimator and the codes comprised in the codebook.

20. The apparatus of claim 17, wherein the feedback controller selects codes orthogonal to a code for an Eigen vector comprising the largest Eigen value among the at least one code comprised in the codebook, and constructs the selected codes as a set.

21. The apparatus of claim 17, further comprising an Eigen value determiner for calculating a ratio of Eigen values for channel information estimated in the channel estimator,
wherein the feedback controller feeds back the ratio of Eigen values calculated in the Eigen value determiner to the serving node.
